(19) United States
(12) Patent Application Publication
(10) Pub. No.: US 2018/0018614 A1
(43) Pub. Date: Jan. 18, 2018

(54) METHOD AND APPARATUS FOR OPTIMIZING CONSTRAINT-BASED DATA

(71) Applicant: Lightning Bolt Solutions, Inc., South San Francisco, CA (US)

(72) Inventors: Suvas VAJRACHARYA, South San Francisco, CA (US); Candace L. CAPPS, South San Francisco, CA (US); Rahul VAIDYA, South San Francisco, CA (US); Shardul SARDESAI, South San Francisco, CA (US); Pelin DAMCI-KURT, South San Francisco, CA (US); Nirmal GOVIND, South San Francisco, CA (US)

(21) Appl. No.: 15/461,884

(22) Filed: Mar. 17, 2017

Related U.S. Application Data
(60) Provisional application No. 62/362,985, filed on Jul. 15, 2016.

(51) Int. Cl. G06Q 10/06

(52) U.S. Cl. CPC G06Q 10/063116

(57) ABSTRACT

Embodiments of the technique disclosed include a computer-based system and method for creating schedules that matches total supply of clinicians with the projected demand in services as well as meet plurality of constraints that consists of scheduling rules and clinician availability/preferences of varying weighted values to ensure work-life balance and thereby avoid staff burnout. In some embodiments, the system predicts the demand in appointments and the capacity of clinicians based on past data, leading to greater accuracies for subsequent schedule creations.

### CROSS-REFERENCE TO RELATED APPLICATIONS

This application claims priority to the U.S. Provisional Patent Application No. 62/362,985 filed on Jul. 15, 2016 which is incorporated herein by reference in its entirety.

### TECHNICAL FIELD

The present application is related to data management, and more specifically to methods and systems for evaluating constraint-based data.

### BACKGROUND

Staff scheduling is the process of matching a list of employees with a list of shifts or assignments for a specified date range. The choice of a particular individual for a given assignment on a given day is generally subject to several constraints imposed by institutional scheduling policies and individual/group preferences. Scheduling a large task force in the presence of a large number of such constraints makes manual scheduling a daunting task. In many cases, manually preparing a schedule that addresses each constraint is infeasible. Institutions with a large number of constraints, including individual's performance relative to the other individuals in the labor pool, renders manually addressing each constraint an insurmountable task.

### SUMMARY

Embodiments of the technique disclosed include a system and method for creating schedules that matches total supply of clinicians with the projected demand in services as well as meet plurality of constraints that consists of scheduling rules and clinician availability/preferences to ensure work-life balance and thereby avoid staff burnout. A web server of the scheduling system can host a website accessible to a user to receive data from the user. Received data is stored and analyzed by components of the scheduling system including a database server and a solver server.

Workforce scheduling requires building work schedules several weeks or several months into the future to allow for planning of personal time-off and other worker constraints that need to be met for work-life balance and human resource requirements. The number of variables and overall complexity in creating these long-term or macro schedules force conventional systems and human schedulers to schedule staff at the granularity of whole days or half-days. However, the calculation of productivity or capacity of staff are most accurate when the granularity of scheduling is much finer since meetings, travel-time, administrative or other such non-productive activities having durations of few minutes, not whole days or even half-days can significantly impact total capacity for the day. Without consideration for such fine-grained activities, conventional methods in scheduling make poor scheduling decisions based on inaccurate information about the true capacity of staff on the schedule. Embodiments of this invention offer ways to efficiently represent, organize and process data in long-term schedules in modern computers without losing the fine-grain information that reflects the true capacities of workers; it offers methods to produce long-term macro schedules with all the precise/detailed information available in micro schedules.

The number of possible schedules for a group of ten doctors and three assignments for a period of a month exceeds the number of atoms in the known universe. This massive combinatorial explosion of possible schedules make it necessary to intelligently search for schedules that meet the user-specified constraints. Simply iterating through all the possible schedules would not complete within one's lifetime even on the fastest of modern computers. An embodiment of the invention builds a mathematical model of the scheduling problem to be solved by a Mixed Integer Programming (MIP) Solver. In this embodiment, the system provides a graphical user-interface to receive user-defined scheduling rules (constraints) along with constraints to match demand with supply, and those inputs are converted into a plurality of mathematical inequalities to create a mathematical model that describes the scheduling problem. The mathematical model is then submitted to a commercially available MIP Solver, which solves the mathematical model to efficiently produce a schedule that best meets the user-specified constraints expressed as inequalities.

An alternative embodiment avoids mathematical modeling by providing a graphical user interface that supports the user to manually build schedules using user's intuition and experience in scheduling. In this alternate embodiment, the system informs the user on the current gap between demand and supply as well as provide information on the impact of selecting a particular clinician on the overall effort to reduce the gap.

Building a schedule that matches demand with supply requires a projection of daily demand in services. Some embodiments involve using predictive analytics to predict the demand for services based on historical demand data. Alternate embodiments provide graphical user interface to specify expected demand for services.

Building schedules also require projection of staff capacity, which also varies day by day. Some embodiments offer a graphical user interface that allows users to statically assign different work templates containing prescriptions for their daily capacities. For example, on a specified day, a “High Frequency” work template might require clinicians to see three new patients every fifteen minutes, whereas “Low Frequency” work template might expect clinicians to see only 1 new patient. In an alternate embodiment, the user only defines flexible rules that limit daily capacities, and the system dynamically determines the appropriate clinician work templates that best meet forecasted demand.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 is a block diagram of a scheduling system connected to devices over a network, according to an embodiment.

FIG. 2 is a block diagram of a scheduling system having a plurality of servers, according to an embodiment.

FIG. 3 is a block diagram showing a method for generating a schedule, according to an embodiment.

FIG. 4A is a chart showing work units for different work types associated with staff profiles, according to an embodiment.

FIG. 4B is a chart showing predicted work units for various time periods, according to an embodiment.

FIG. 5 shows a generated schedule for a plurality of staff profiles configured to satisfy the predicted number of work units to be performed over a plurality of time periods and accounting for a plurality of constraints, according to an embodiment.

FIG. 6A shows “Medium Frequency Work Template” among a plurality of static work templates at a granularity of 30 minutes, according to an embodiment.

FIG. 6B shows a static work template among a plurality of staff profiles at a granularity of 30 minutes, according to an embodiment. Since total work commitment for a clinician is greater (more total units of work for the day), this work template is named “High Frequency Work Template”.

FIG. 6C shows an example schedule of static work templates assigned to clinicians on plurality of dates according to an embodiment.

FIG. 7A shows a dynamic work template, according to an embodiment. Dynamic work templates are more flexible than static work templates because the actual amount of work assigned to a clinician will be determined by the system based on rules specified on the template and based on projected demand and supply on that day.

FIG. 7B shows a plurality of constraints for dynamic work template that applies to a group of clinicians, according to an embodiment.

FIG. 8 shows graphical user interface (GUI) depicting calendar of clinician availability, according to an embodiment. Clinicians use the depicted GUI to reserve time-off and see the impact of their leave on total capacity (Cap) toward demand target (Tar).

FIG. 9 shows weighted values for a plurality of scheduling rules, a form of constraints, according to an embodiment.

FIG. 10 shows a manual scheduling user interface selecting alternates, according to an embodiment.

FIG. 11 is a block diagram showing a method for generating a schedule, according to an embodiment.

FIGS. 12A-12C show charts of clinician capacity derived from work templates, according to an embodiment.

FIG. 13A shows a graphical user interface that allows users to define a scheduling rule by selecting one of the rule templates, according to an embodiment.

FIG. 13B shows the graphical user interface for defining a conditional rule based on selecting a rule template listed in FIG. 13A, according to an embodiment.

FIG. 13C shows how the user's definition of scheduling rules in FIGS. 13A and 13B can be represented and stored in system database, according to an embodiment.

FIGS. 14A-14B show list of conditional rules templates a user can select from in when defining a conditional rule, according to an embodiment.

FIG. 15 shows rules templates that allow users to describe whether to schedule or not schedule a clinician on specific assignments on dates specified by a recurrence pattern, according to an embodiment.

FIG. 16 shows examples of rule templates that impose a minimum or maximum number of times a clinician should be scheduled to specified assignments during specified time window expressed in days, according to an embodiment.

FIGS. 17a and 17b show examples of rule templates that express the desired work distribution amongst clinicians, according to an embodiment.

FIG. 18 shows examples of consecutive time period constraints, according to an embodiment.

FIG. 19 is a diagrammatic representation of a machine in the example form of a computer system within which a set of instructions for causing the machine to perform one or more of the methodologies discussed herein may be executed, according to an embodiment.

### DETAILED DESCRIPTION

Embodiments of the present invention involve creating a work schedule that meets projected demand for services with projected staff capacity while also ensuring work-life balance and work preferences of staff on the schedule. The invention applies to various sectors including, for example, the healthcare sector. Discussion of a particular sector is by way of example and should not be construed as limiting the scope of technique disclosed herein unless expressly stated.

Demand/Supply.

Conventional computer-based methods for matching supply with expected demand amounts to scheduling a sufficient number of clinicians to be available. For example, if 90 patients are expected per day, and each clinician can serve nine patients, the system would schedule ten clinicians. This inaccurately reflects demand and supply for several reasons:

1. Daily capacity of clinicians is not all the same. Some clinicians are more productive than others depending on the type of service (new appointment, return appointment, etc.).
2. Not only are the capacities different per clinician, capacity of the same clinician varies day by day. Events such as meetings, administrative time, travel time between facilities, personal time-off all reduce the total capacity and varies day by day. Such events have impact on capacity at the granularity of minutes; a fifteen-minute meeting reduces the capacity of that clinician for the day.
3. Furthermore, capacities for the same clinicians change over time. For example, a new hire might be less productive for the initial months of employment.
4. Demand varies throughout the year. For example, the flu season might bring a greater number of patients than other times of the year.

Human Resources Requirements Such as Work/Life Balance.

In service industries like healthcare, the matching of supply to demand cannot be the only consideration particularly in industries where there is a shortage of skilled laborers and work-related burnout is common. This is particularly important in industries where services are rendered 24 hours a day, seven days a week and 365 days a year. Rules need to be imposed to ensure sufficient rest between shifts and avoid certain work-patterns such as working a morning shift after a night shift. Work/Life considerations need a long-term view, typically several weeks, months or even years: vacations need to be planned months in advanced, limits on number time a clinician is on-call needs to be imposed per week, month or year; number of holiday shifts worked is measured over several years. In sum, choice to schedule a clinician on any given day depends on not only that day but the scheduling choices made on different days, weeks, and months before or after that day. This long-term requirement of work-life balance conflicts with the effort to achieve greater accuracy in achieving balanced demand/supply since they are determined by events at the granularity of minutes. Scheduling for work-life balance also require hundreds of rules and dozens of rule types, which is also not addressed by conventional systems.

Combinatorial Challenge.

The total number of possible schedules for one assignment for two docs is sixteen for just two days. In general, there are 2^{D*C*A} possible schedules for C clinicians, D days, and A assignments. For a realistic schedule consisting just three clinicians, four assignments for 30 days would mean there are 2.3×10¹⁰⁸ possible schedules, which exceeds the number of atoms in the known universe. This has sobering impact on naïve implementations where you iterate through every possible schedule and pick the one that best meets the supply/demand, work/life balance constraints because such an implementation would never finish in one's lifetime on modern computers. As a result, conventional methods in practice have one or more of the following drawbacks:
1. Schedule for only a few days, compromising the long-term view that work/life balance requires.
2. Ignore the intra-day events like meetings that impact capacity calculations.
3. Does not find schedules that best meets all the constraints

Projections.

Schedules are built based on expected demand and supply, both of which are projections. If these projections are inaccurate then the schedules based on the projections are inaccurate. Conventional systems and manual methods do a poor job learning from past data in making accurate projections.

Conventional methods result in suboptimal schedules that negatively impact the business of healthcare and the quality of patient care. Medical group managers lose key clinicians due to poor work-life balance, which further exacerbates the supply problem. When supply does not meet demand, healthcare organizations also lose patients to competitors who might be able offer an appointment sooner. Studies show that patients change their primary care provider if they are able to consistently find appointments sooner with another clinic or care delivery network. Timeliness of appointments trumps all other determinants in patient satisfaction, including bedside manners, facilities, and proximity of clinic. In addition to the business impact, changes in primary care provider negatively impacts patient outcomes because of the break in the continuity of care.

Embodiments of present invention overcome challenges in conventional methods. The technique disclosed includes a system and method for creating a schedule that accounts for a plurality of constraints, such as those arising from the need to match supply to demand, and the need to achieve work-life balance for clinicians, by converting the constraints into a set of mathematical inequalities (and thereby creating a mathematical model) that can be solved efficiently by a commercial solver. The constraints expressed mathematically are then solved simultaneously using commercially available Mixed-Integer Programming (MIP) Solvers to ensure that patients are seen in a timely fashion without burning out clinicians who serve them. The framework and organization of data presented here lead to methods to predict future demand for services as well project expected capacity or productivity of clinicians based on historical data. Thus, schedules generated using the disclosed method can be more closely tailored to staffing needs of an organization than is possible with conventional methods.

Some embodiments involve using data analytics to determine a performance characteristic for any staff profile of a plurality of staff profiles which can be used to determine how many work units can be accomplished by any staff profile of the plurality of staff profiles. Some embodiments involve predicting a number of work units to be performed over a plurality of time periods based on, for example, historical appointment data. Data structures (e.g., including staff profiles, performance characteristics, target work units, etc.) are merged and updated in a database (e.g., within a database server). The system converts these data structures into constraints in the form of mathematical inequalities, which then become criteria for a massive search for a schedule that best meets as many constraints as possible. Since the number of possible one-month work schedules in a medical group of just eight doctors can exceed the number of atoms in the known universe, even the fastest modern computers cannot iterate through every possible schedule and select ones that match the given constraints. The invention uses a form of combinatorial optimization that creates a mathematical model and uses MIP Solvers to efficiently examine only the schedules that are likely to meet user-defined constraints.

This invention improves upon conventional scheduling methods by describing:
1) how demand for services and each clinician's capacity to serve them can be predicted/calculated using data analytics;
2) how those projections can be converted into data structures that can be easily accurately and efficiently represented and manipulated in a modern computer; and
3) how those data structures can be converted to mathematical inequalities in a form that a MIP Solver can use to efficiently search for a schedule meeting the user-defined constraints.
The third part of the invention amounts to automatically generating a schedule using artificial intelligence since the system thinks deeply to consider which combination of clinicians lead to an acceptable schedule. This third part of the invention is optional because a user of this invention can manually manipulate schedules based on intuition and experience to navigate through possible schedules using the user interface suggested here and still benefit from first two inventions described above since they guide the human schedulers with accurate information at their fingertips to guide the choice of clinicians to schedule each day.

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “Named Assignment Block” and acronym “NAB” refer to assignment blocks at granularity of several hours or whole days. For example, a doctor might be scheduled for Clinic AM which is from 8:00 am to 12:00 pm, Clinic PM from 1:00 pm to 5:00 pm or Clinic All Day from 8:00 am to 5:00 pm. As another example, a doctor can be assigned to a Meeting for 1 hour from 10:00 am to 11:00 am. Clinic AM, Clinic PM, Clinic All Day and Meeting are all examples of NABs. Long-term or Macro scheduling occurs at the granularity of NABs.

The term “Targeted Work Type” refers to a particular category of work. One or more NABs may belong to a Targeted Work Type. Each Targeted Work Type has a projected demand target value measured in some unit of work. For example, doctors might have to see returning patients, or new patients each considered different types of work. In this example, the projected demand for Return Appointments might have a numerical target of ten units total for all clinicians working on that day, whereas as New Patient Appointments might have a projected demand of twenty work units. When a clinician is assigned to an NAB, the supply count for the Targeted Work Type associated with that NAB is increased to reflect allocation of the clinician resource. For example, when a clinician is assigned to NAB, Clinic AM, the counter indicating total supply for Return Appointment associated with Clinic AM would be updated to a higher value.

The term “Activity Item” refers to a fine grain (five minutes to fifteen minutes) activity or task performed by a clinician working that day. Each activity item user specifies the name of the activity, the start and stop time of that activity as well as the expected capacity or productivity expected during that time. For example, from 8:00 AM to 8:15 AM, a doctor might be assigned to Activity Item called “Return Appointments” with expectation of seeing three patients. “Micro Scheduling” occurs at the granularity of Activity Items.

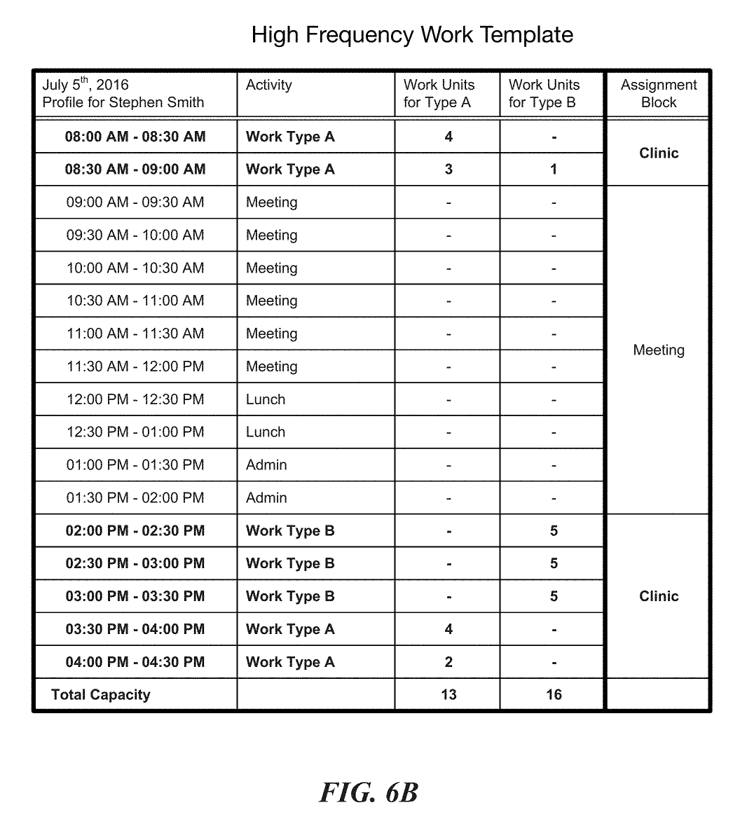

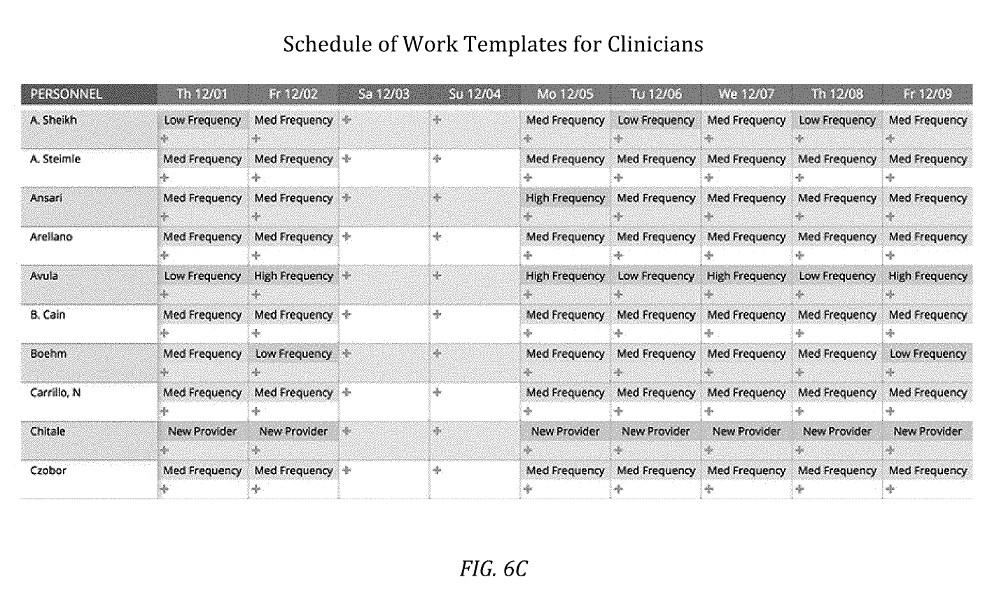

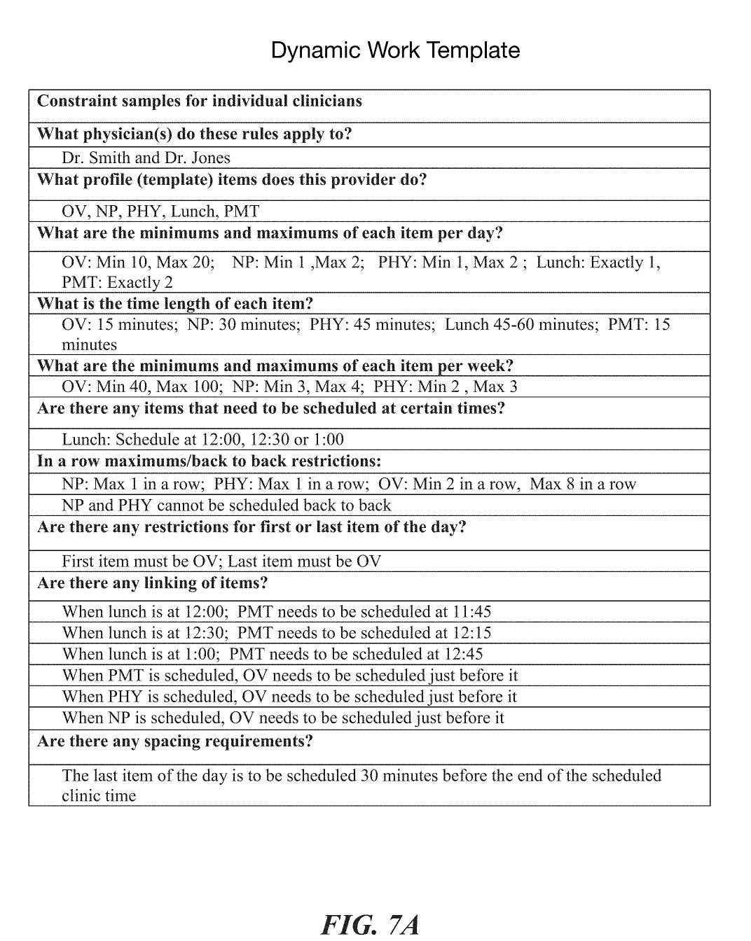

The term “Work Template” refers to a daily schedule consisting of a list of Activity Items that a clinician performs during the day. FIGS. 6A and 6B show an example of Activity Items in a Work Template. Work Template is a “Micro Schedule.”

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Overview

Embodiments of the invention concern rule-based software systems that automatically produce an optimized schedule that:

(1) meets work-life balance requirements for clinicians including their time-off needs; and
(2) matches the projected demand with the total supply calculated based on projected productivity of clinicians.

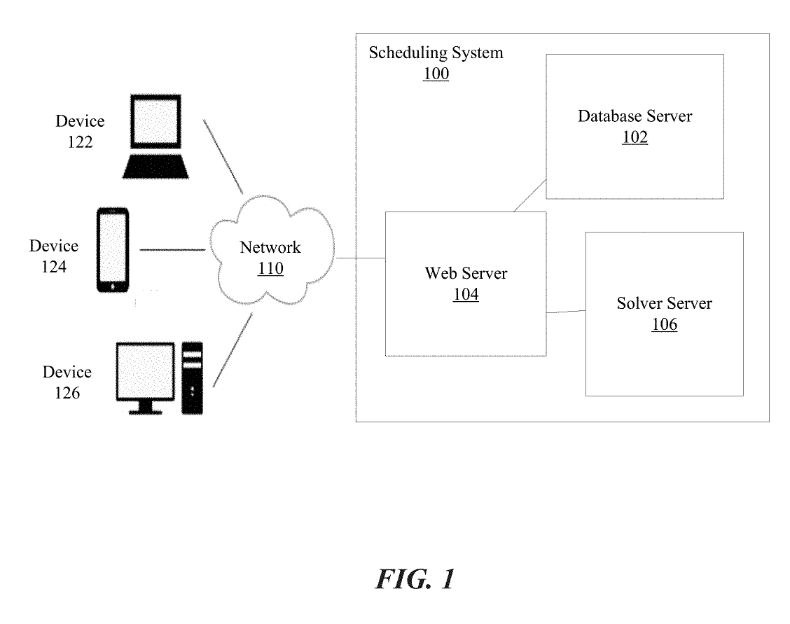

FIG. 1 is a block diagram of a scheduling system 100 connected at least one device (e.g., device 122, device 124, and device 126) over a network 110, according to an embodiment. The scheduling system 100 includes a database server 102, web server 104, and solver server 106. The database server 102 includes one or more databases including, for example, raw data received via the network 110 and data generated from web server 104 and solver server 106 (e.g., insights derived from raw data). Web server 104 hosts a website and manages HTTP requests from connected devices (e.g., device 122, device 124, and device 126). Solver server 106 analyzes data, including data inputs received by the scheduling system 100.

The scheduling system 100 takes four inputs: (1) demand for services, (2) daily work templates with productivity information for each of the service providers, (3) service providers' time-off requirements, and (4) scheduling rules. The scheduling system 100 produces two outputs including (1) optimized work schedules, and (2) schedule reports. The outputs can be further analyzed, along with external data on work productivity to further project the demand for services as well as projected productivity of individuals. These projections can be used as input for next iteration of future work schedules.

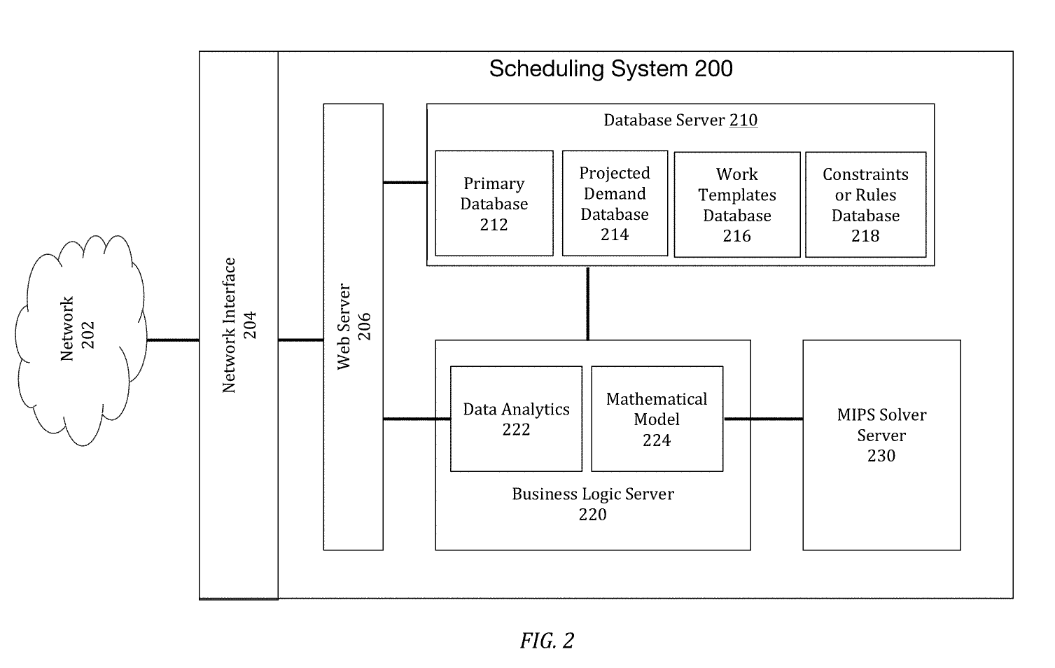

FIG. 2 is a block diagram of a scheduling system 200 having a plurality of servers (e.g., web server 206, database server 210, business logic server 220 and solver server 230), according to an embodiment. The scheduling system 200 can be connected to network 202 via a network interface 204. The network interface can be part of web server 206 or another computer.

Web server 206 can manage communication with devices connected to the scheduling system 200 via the network 202. Web server 206 can host a website providing a platform for receiving inputs from connected devices. Received inputs can be provided to database server 210 for storage in primary database 212.

The database server 210 can include primary database 212, projected demand database 214, work template database (containing information on clinician capacity used to calculate supply) 216, and constraints or rules database 218 (containing requirements for work-life balance for clinicians). The primary database 212 can include unprocessed primary data (e.g., raw data) received from, for example, web server 206. In one embodiment, projected demand database 214 and work template database are derived from the data in unprocessed primary database received from web server 206. In other embodiments, projected demand and work templates are derived from input received from web server 206 along with internal data analytics 222, which uses historical data to predict demand and clinician capacity. Mathematical model 224 is derived from data contained in primary database 212, projected demand database 214, work template database 216 and rule database 218. The resulting mathematical model is submitted to MIP Solver server 230, which produces best possible schedule and returns it to business logic server 220 to present back to user via web server 206.

The Business Logic Server 220 consists of two modules that together provides the intelligence that scheduling system 200 provides. Data Analytics module prepares two inputs needed for the system—the predictive modeling of demand for services, and the capacities of the clinicians both of which relies on historical data. Some embodiments can do without the Data Analytics by having those projections be done outside of the system and receiving those inputs directly from user via Web Server 206.

Mathematical modeling modules takes the inputs stored in Database Server 210 (received from Web Server 204, the inputs generated by Data Analytics 222), to create a mathematical model consisting of inequalities that constrain user-defined objective functions. The resulting model is sent to a commercial MIP Solver 230, which searches for feasible solutions and returns the best schedule it can find back to the Business Logic Server 220. With some additional processing to prepare for presentation to the user, it is then presented to the user in a graphical user interface using the web server 206. Some embodiments can do without the Mathematical Model module and rely instead on users intuition and experience to build a schedule manually using a graphical user interface that supports user decisions.

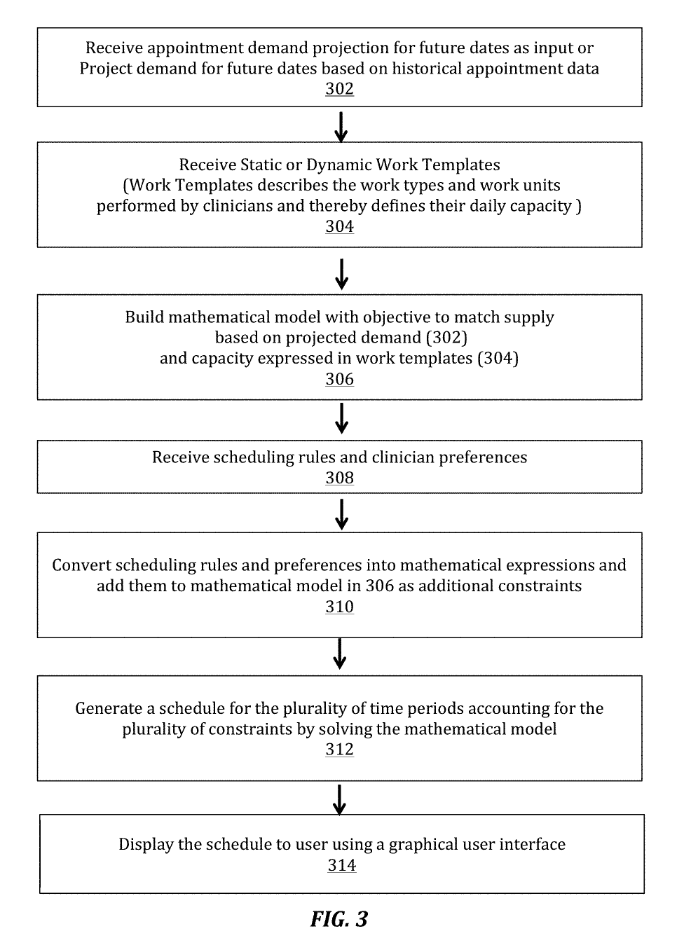

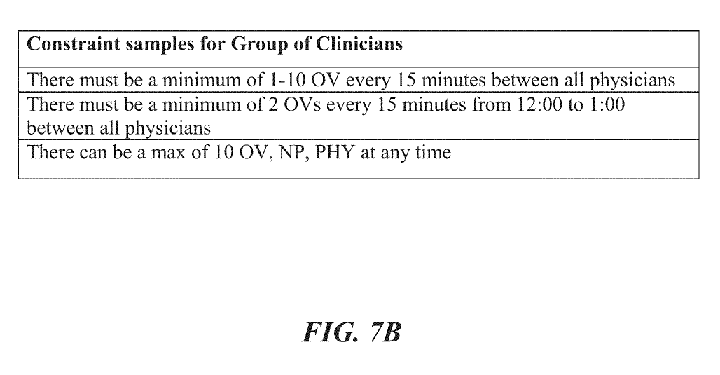

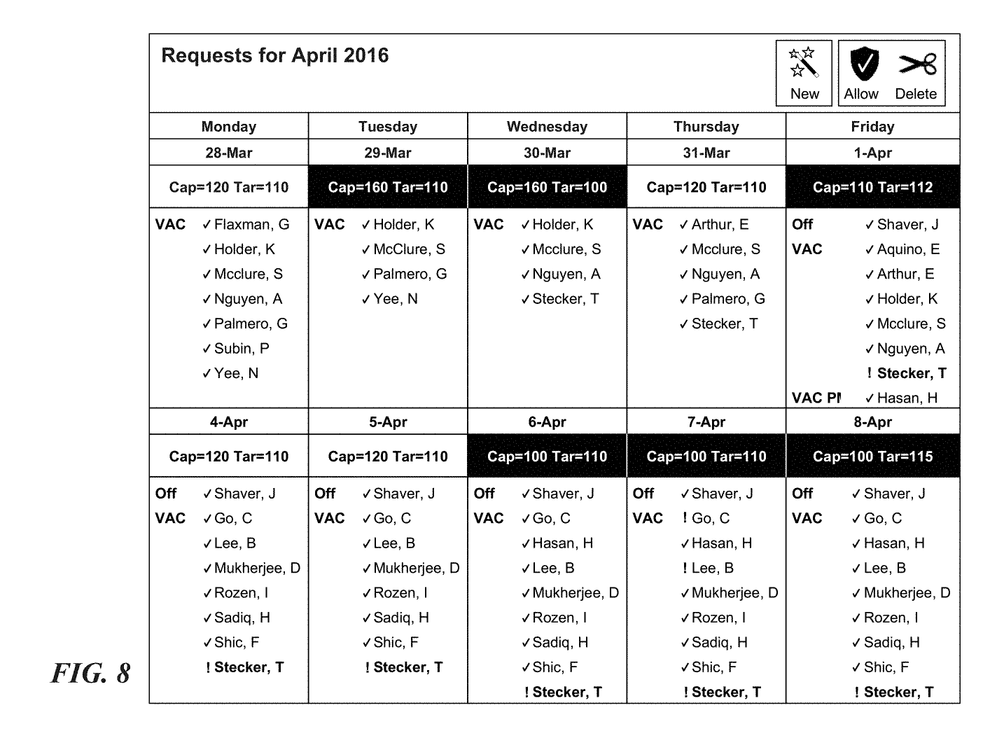

FIG. 3 is a block diagram showing a method for generating a schedule, according to an embodiment. The method can be performed, for example, by a processor of the scheduling system 200 executing instructions. The method can include, for example, receiving projections of demand for services or in lieu of such projections, receiving historical appointment data that can be used to make the missing projections as a first step (step 302), receiving Static or Dynamic Work Templates as shown in FIGS. 6A, 6B, 6C, 7A, 7B as a second step (step 304), converting the demand/supply inputs from prior steps into a mathematical model for a user-specified time-period (step 306), receiving scheduling rules, clinician availability and preferences (step 308), and converting those to additional constraints to complete the mathematical model for the specified time period (step 310) before submitting to MIP Solver to generate a schedule (step 312) and presenting the schedule for the specified time period back to user using web-based graphical user interface.

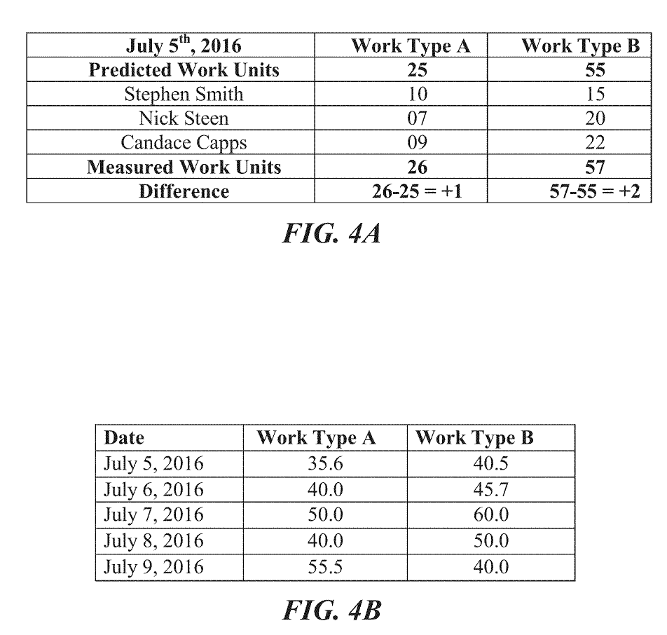

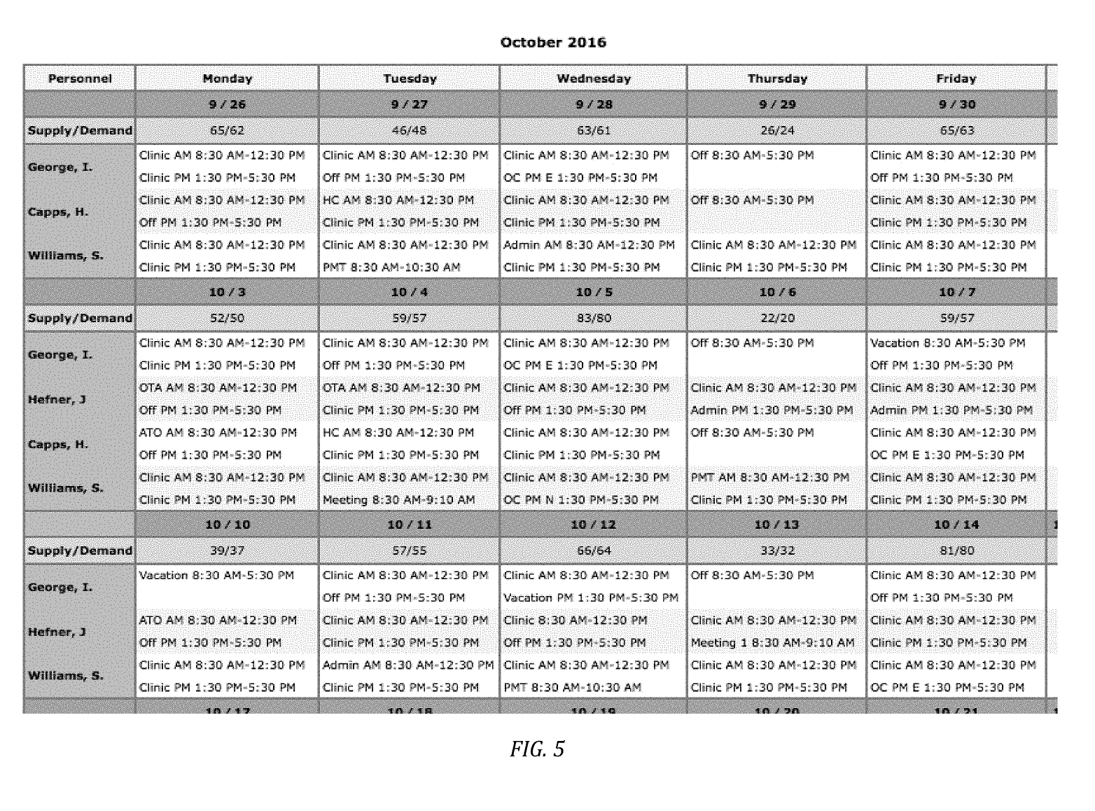

Step 302 involves establishing a key input into the system, the projected demand for services on different dates. In one embodiment, users can project demand for services outside of the system and input the projection by uploading a file with a list of <date, work type, expected_demand_value> pairs where the expected_demand_value is total demand measured in some units for the specified type of work. The file will contain as many entries as there are days forecasted. In alternate embodiments, the user uploads a file of historical patient appointment data for at least a year in the past in the same format, and the system uses statistical analysis and predictive modeling to project demand for services in the future. Users can additionally control the system's projection for demand by specifying a <begin_date, end_date, work type, percentage_change> to indicate expected percentage of increase or decrease in demand for the specified work type for the specified date range over the same period preceding year. The resulting projections are stored in a database as shown in FIG. 4B.

Step 304 involves establishing a second key input into the system, the work templates that determine the rate or intensity of work performed by clinicians and assignment of those templates with specific clinicians. Work template is a daily micro schedule describing minute-by-minute activities that a clinician might perform. In short, this step establishes the parameters that make up the daily supply needed to meet demand. Users can express work templates in either static or dynamic form. FIG. 6A shows a static work template which shows that clinician working this template on any day will contribute a total capacity to work ten work units for work type A and 15 units of work type B. In static work templates, the projection of capacity of the clinician assigned to this template is absolute or fixed. In a dynamic work template (FIG. 7A), the total capacity of work performed by clinician assigned to them is not fixed but determined by the system. Dynamic templates provide the system the flexibility to change the daily work template based on need, such as total demand, and total clinicians capacity/availability that day. The eventual template with absolute daily schedule similar to that of static work template is produced by the system as an output.

Once the work templates have been defined, the user can specify which templates apply to which clinician on different days by specifying a schedule of work templates as shown in FIG. 6C. Different templates need to apply on different days because the demand is expected to be different per day, and because clinician availability/preference also vary day-by-day. For example, there might be greater demand for services on Mondays. As another example, Dr. Jones might be able to take on first Wednesday of every month.
In an embodiment, system can allow the both static and dynamic templates to be updated to more accurately reflect the true capacity based on actual/historical performance. For example, if clinicians assigned to High Frequency Work Template (FIG. 6B) actually complete five units of work Type A instead of the projected 4 units during 8:00 am to 8:30 am consistently (i.e. significant statistically), then the system updates the tally to four from five.
Work templates and the schedule of work templates provide the means for the system to determine the capacities of clinicians at the granularity of minutes.

Step 306 involves converting the objective to reduce the gap between target demand for services and clinician capacities to perform them into mathematical inequalities. This step is required for the system to automatically generate a schedule that matches demand with supply. The general requirement is that for each day being scheduled, the sum of the capacities of clinicians for each work type needs to be equal to or greater than the projected demand. The demand for a work type per day is simply a value received from user or generated in Step 302. To determine the capacities per clinician, the system sums up the activities in the work template as shown in FIG. 4A. For example, on Jul. 5, 2016, Stephen Smith's total capacities for Work Type A and Work Type B are ten and fifteen respectively based on the Work Template in FIG. 6A. Note that these capacity values for Stephen Smith are a result of Medium Frequency Work Template being assigned to that clinician on July 5^{th}. For example, Stephen Smith's capacities on that day would be higher if he was assigned High Frequency Work Template instead. The system dynamically selects clinicians and the appropriate work template they are to work to ensure their collective supply meets the projected demand for each day.

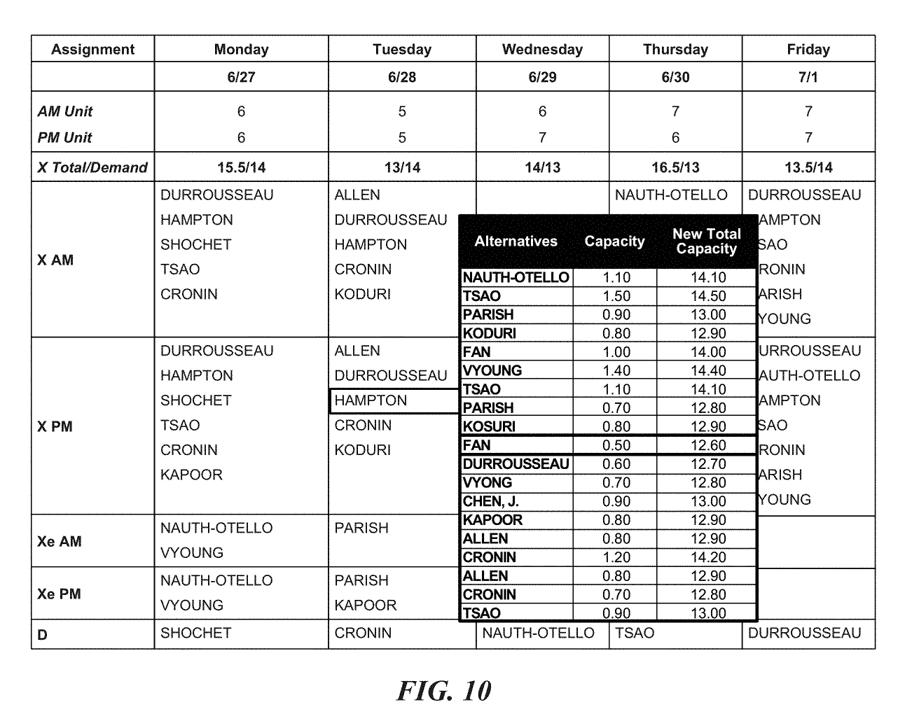

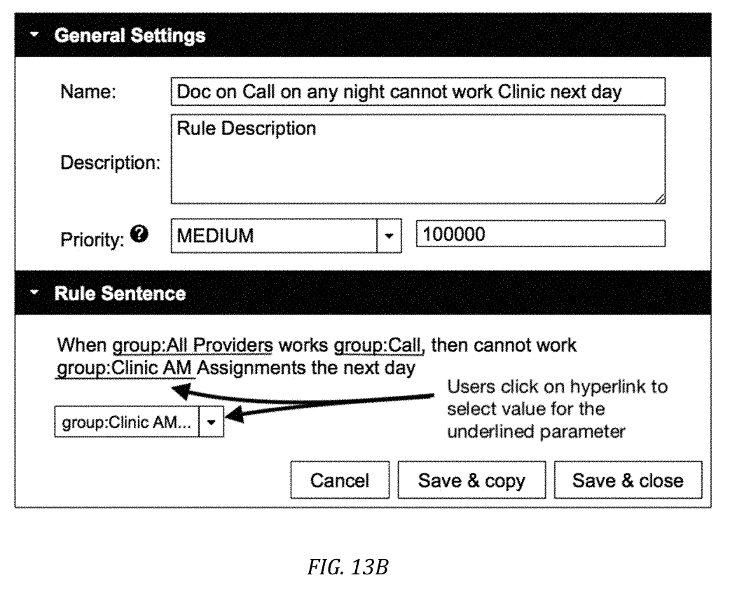

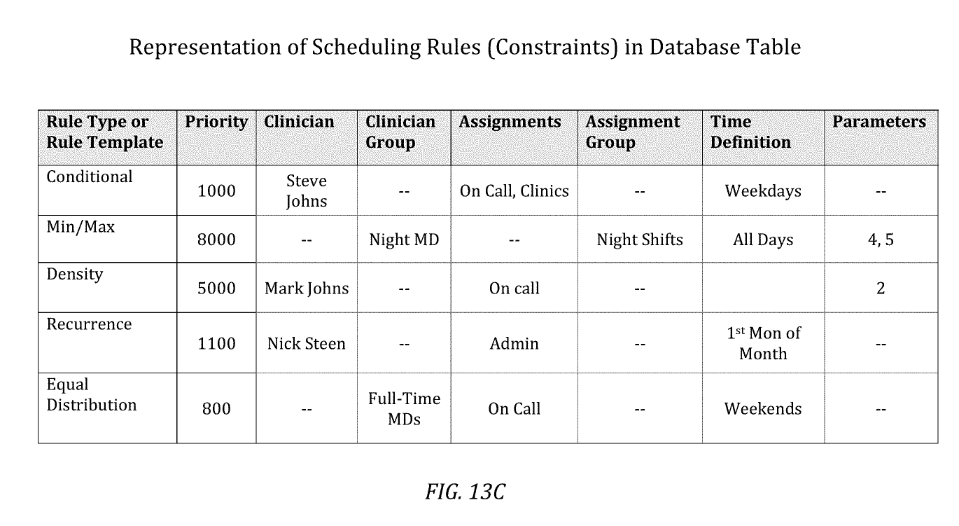

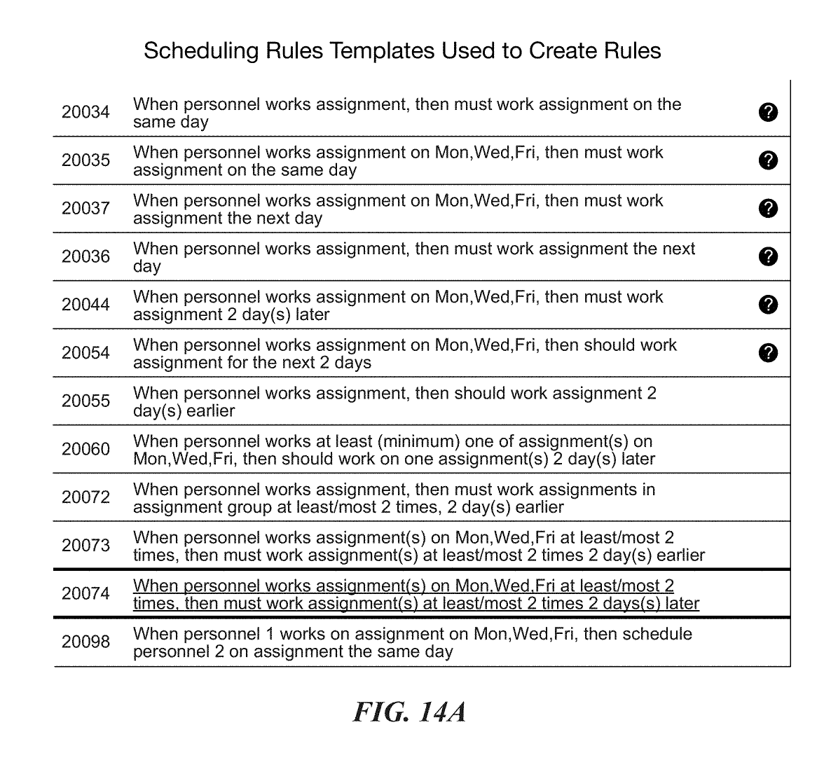

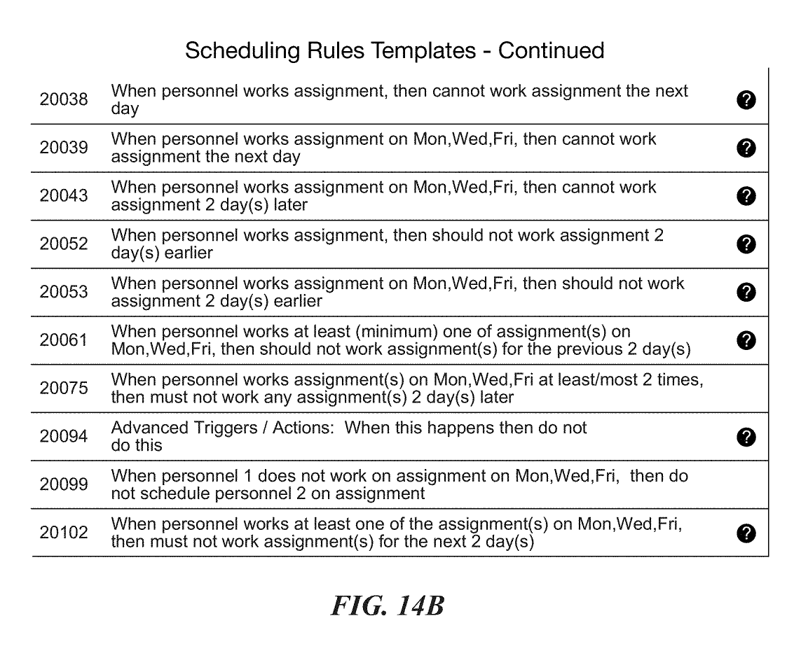

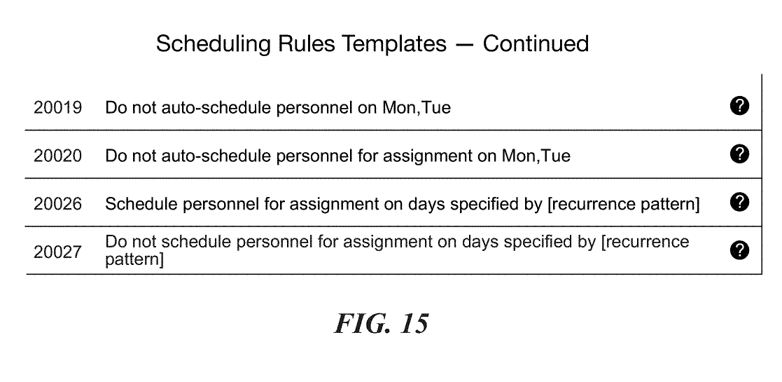

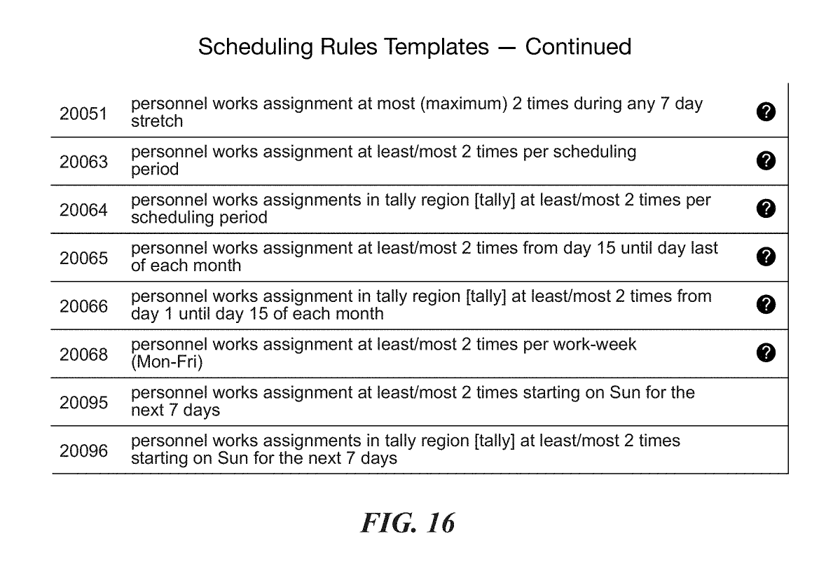

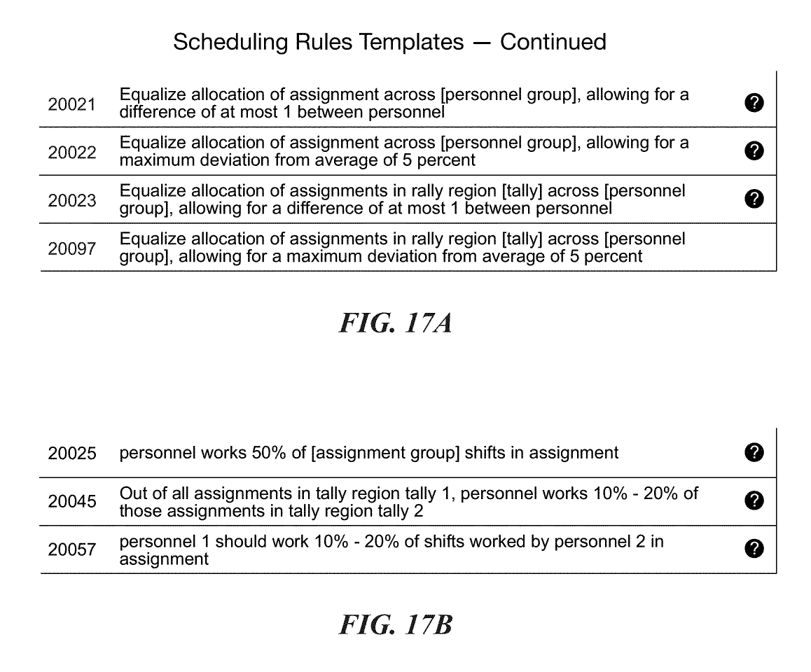

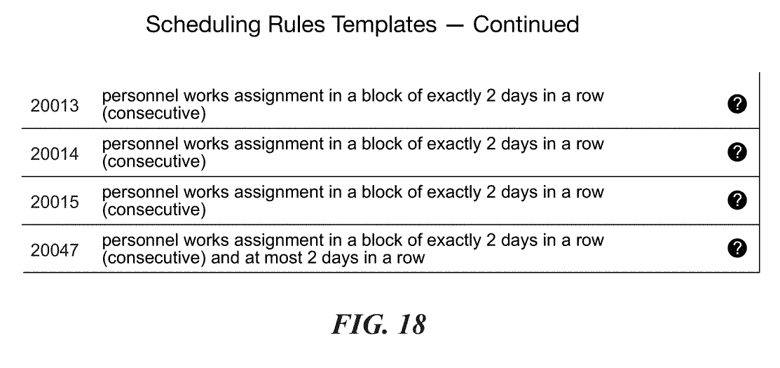

Step 308 involves receiving scheduling rules and clinician preferences such as time-off requirements and preferences to create a plurality of constraints to be stored in a database. In addition to meeting business requirements, these constraints ensure a work-life balance for clinicians and protect them from work patterns that cause burnout. Examples of rules or constraints are shown in FIG. 9. When the sum of all constraints is not mathematically feasible because they conflict with one another, the system determines the relative importance of constraints by looking at the user-defined priorities as shown in the figure. This means a higher priority rule may override a lower priority rule if both rules cannot be met. FIG. 13A, 13B shows how the graphical user interface of an embodiment graphical user interface allows users to choose a template of rules (FIG. 13A) and upon selection, fills out a template form (13B) to define the rule with parameters that apply to the selected template. FIG. 13A shows an embodiment that classifies rules into different categories, and the category for rules that control the minimum and maximum number of times a clinician should work is expanded in the figure. FIGS. 14A, 14B, 15, 16, 17A, 17B, and 18 show other possible templates a user can select, in an embodiment.

FIG. 13B shows the form that applies to the choice of a conditional rule template with a Rule Sentence (see bottom of the form in the figure) that applies to conditional rules. Other rule templates would need different rule sentences with different parameters for users to specify. Once the form has been saved by the user, the system populates a row in a database table for each constraint, summarizing the main parameters entered in the form, as shown in FIG. 13C. Note that the description at the top of the form, “Doc on Call on any night cannot work Clinic next day” which correspond to the verbiage on list of rules presented in FIG. 9, is only a description in natural language (English); it is not interpreted by the system. The elements in the database table (FIG. 13C) contain all the information needed to express the constraint as mathematical inequalities (which is described as a next step, step 310).

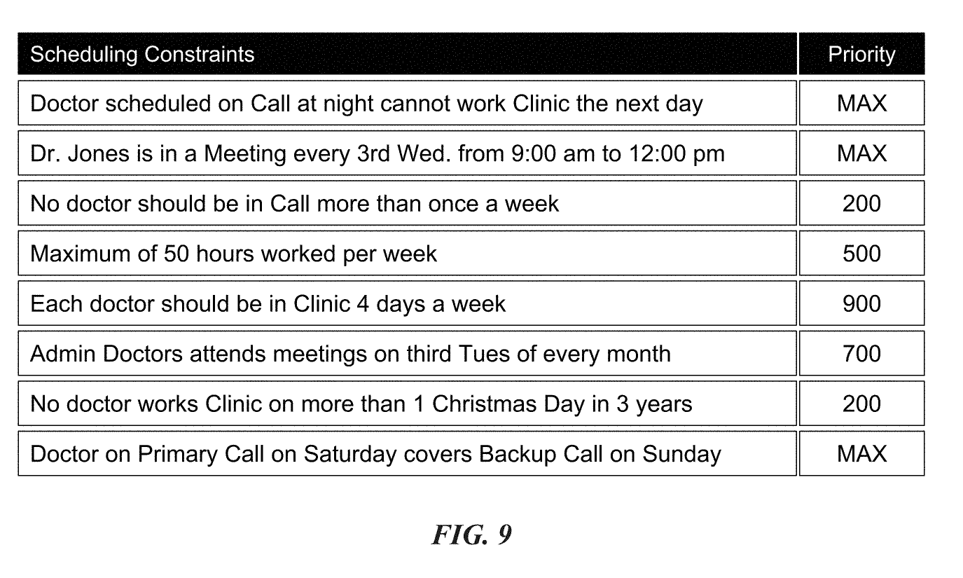

In addition to collecting scheduling rules, step 308 includes the collection of time-off requests such as vacation requests, day-off requests, and requests to be on or off particular type of shift or assignment. FIG. 8 shows an embodiment that uses a calendar-based GUI to collect such requests. These date-based requests are better collected via a calendar GUI than a scheduling rule interface described earlier which is more appropriate for recurring rules that can be described in a rule sentence. For each day in the calendar, clinicians can view the current total capacity (Cap) and total demand target (Tar), and also see the impact of requesting vacation (VAC) or time-off (Off) on the total capacity. If the total capacity (Cap) becomes lower than the demand target (Tar), the system blocks the request from being approved as shown in FIG. 8 for Dr. Stecker on the second week of April. In addition to time-off requests, clinicians could make requests to be on meetings and administrative time all of which reduce the total capacity for the day. As with the scheduling rules, the clinician requests are stored in a database table to be added as additional constraints in the mathematical model. The capacities expressed in work templates indicate maximum potential of a clinician when they are fully available. Overriding events such as time-off and other non-productive events such as meetings during the day would reduce that potential capacity.

Step 310 includes building a mathematical model as part of an embodiment to have the system build a schedule automatically based on user-specified scheduling requirements. This requires conversion of three types of data prepared and stored in database in earlier steps:
1. Conversion of objective to match demand with supply into mathematical inequalities
2. Conversion of meeting scheduling rules and clinician preferences of different types into mathematical inequalities
3. Conversion of clinician calendar-based requests (for time-off, etc.) into mathematical inequalities
   Each constraint converted to a mathematical expression has a penalty (or priority) points associated with the constraint. The objective for the mathematical solver is to find a schedule with a minimum total penalty points.
   Those skilled in the art would readily see how such conversions from entries on the database tables such as those shown in FIG. 13C as well as clinician-requests can be converted into mathematical inequalities. Below is an example of how matching demand with supply gets converted.
   Assuming that on a specific date, we have a projected demand of 25 units of work and the capacity to serve patients for Dr. Stephen Smith is fifteen, Nick Steen is eleven, and Candace Capps is four units the system needs to formulate an inequality for the MIP Solver to solve.

| Jul. 5^{th}, 2016 | Work Type A |
|---|---|
| Projected Demand (Target) | 25 |
| Capacity for Stephen Smith | 15 |
| Capacity for Nick Steen | 11 |
| Capacity tor Candace Capps | 04 |

The corresponding mathematical inequality is as below, where the expression Assign(X,Y,Z) has a value of 1 if Clinician X is assigned to Z on date Y. Otherwise, the expression has a value of 0.

15×Assign(Stephen Smith, 2016_07_05, Clinic)

+11×Assign(Nick Steen, 2016_07_05, Clinic)
+04×Assign(Candace Capps, 2016_07_05, Clinic)>=25

Step 312 includes submitting the system of inequalities to the MIP Solver to produce a schedule. For example, when the above inequality in [0065] is submitted, the MIP Solver would schedule Stephen Smith and Nick Steen because the total of their capacity of 26 units is greater than the demand target of 25. This means the MIP Solver would assign the following values to the inequalities to meet the constraint of demand for service:

Assign(Stephen Smith, 2016_07_05, Clinic)=1
Assign(Nick Steen, 2016_07_05, Clinic)=1
Assign(Candace Capps, 2016_07_05, Clinic)=0

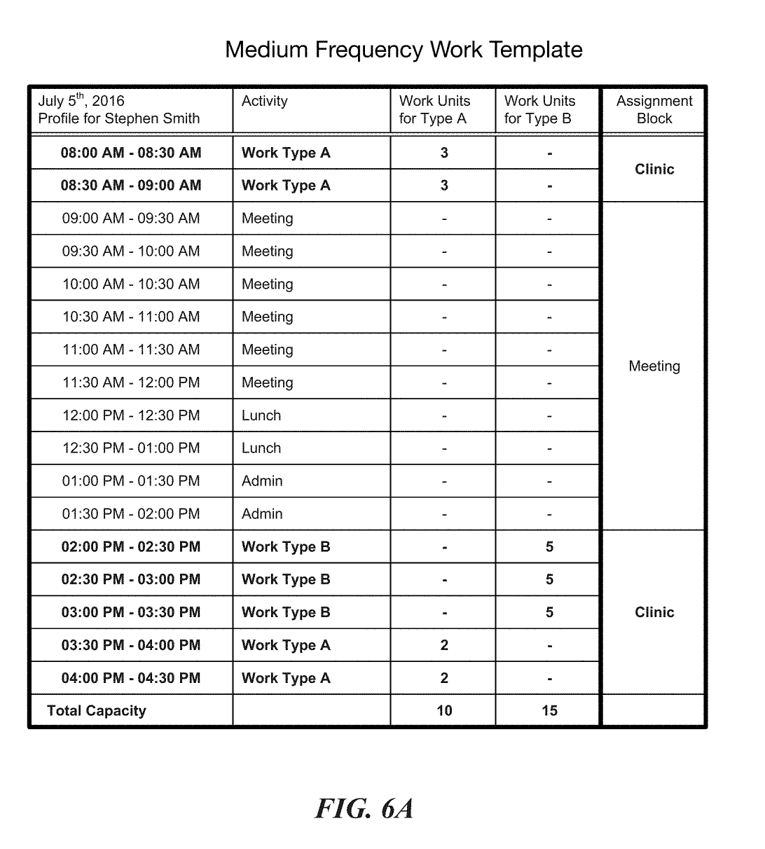

Step 314 involves presenting the scheduling results from MIP Solver on calendar based Graphical User Interface via web server similar to the one shown in FIG. 5 which shows the work schedules for clinicians as well as a measurements indicating whether demand is met with supply.

### Computer

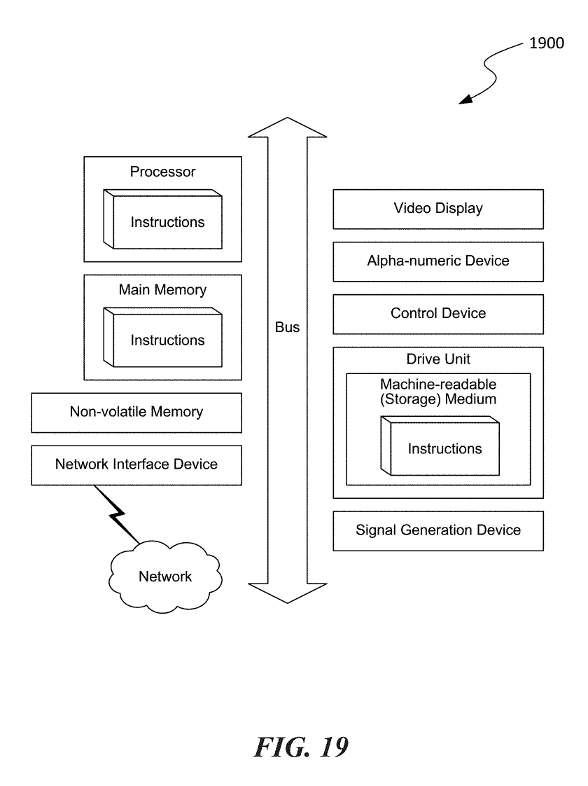

FIG. 19 is a diagrammatic representation of a machine in the example form of a computer system 1900 within which a set of instructions, for causing the machine to perform any one or more of the methodologies or modules discussed herein, may be executed.

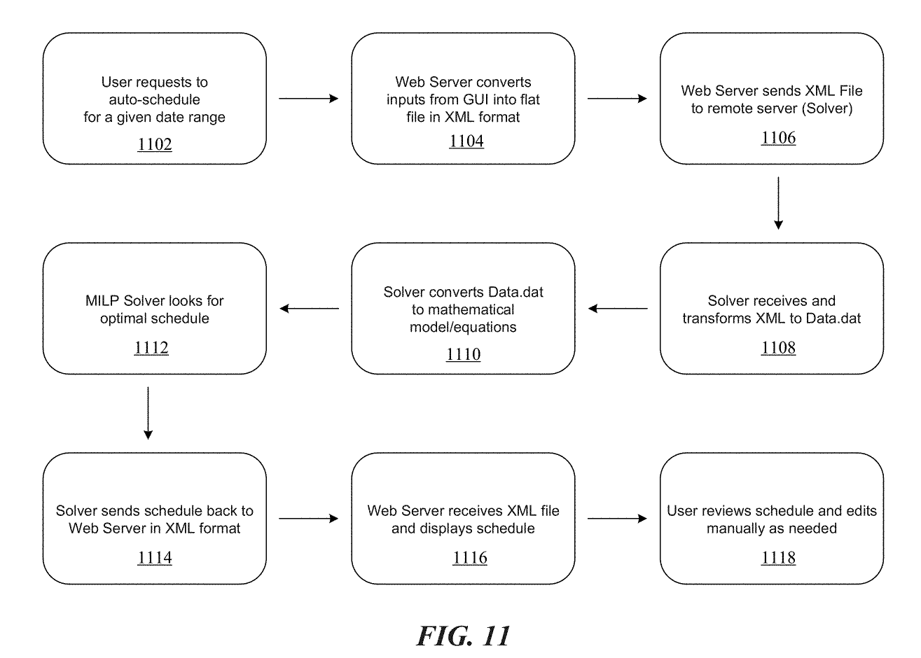

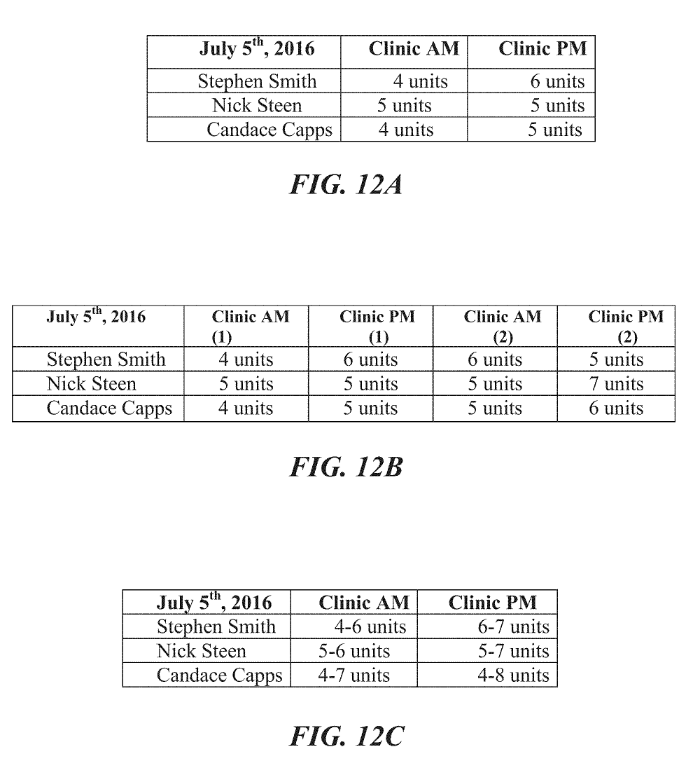

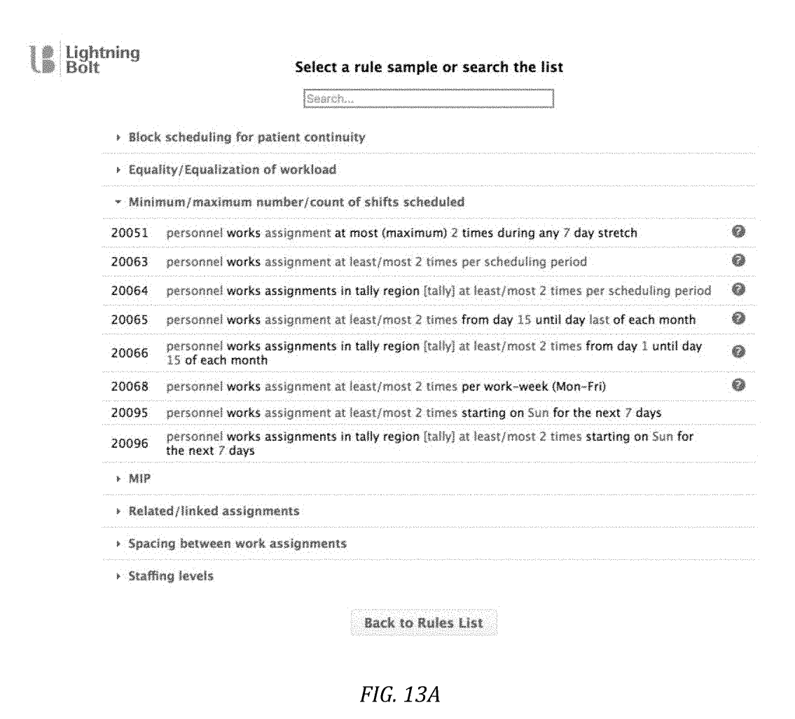

In the example of FIG. 19, the computer system 1900 includes a processor, main memory, non-volatile memory, and an interface device. Various common components are omitted (e.g., cache memory) for illustrative simplicity. The computer system 1900 is intended to illustrate a hardware device on which any of the components described in the example of FIGS. 1-18 (and any other components described in this specification) can be implemented. The computer system 1900 can be of any applicable known or convenient type. The components of the computer system 1900 can be coupled together via a bus or through some other known or convenient device.

This disclosure contemplates the computer system 1900 taking any suitable physical form. As example and not by way of limitation, computer system 1900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1900 may include one or more computer systems 1900; be unitary or distributed; span multiple locations; span multiple machines; or reside in a cloud, which may include one or more cloud components in one or more networks. Where appropriate, one or more computer systems 1900 may perform without substantial spatial or temporal limitation one or more steps of one or more methods described or illustrated herein. As an example and not by way of limitation, one or more computer systems 1900 may perform in real time or in batch mode one or more steps of one or more methods described or illustrated herein. One or more computer systems 1900 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1900. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1900. The interface can include an analog modem, ISDN modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 19 reside in the interface.

In operation, the computer system 1900 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A computer implemented method, comprising:
receiving, with a processor, over a plurality of channels:
a plurality of date-varying projection on demand for appointments,
profiles of clinician capacities comprising daily work templates with information on minute-by-minute projected productivity,
rules or constraints with weighted priority values to ensure work-life balance and avoid clinician burnout;
calculating, with the processor, the true daily capacity of a clinician that is accurate to the minute based on the default daily work template and overriding events comprising any of time-off, meetings, and travel-time that reduce the total capacity expressed in the default work template;
identifying, with the processor, a plurality of constraints, arising from clinician preferences and demand/supply matching, associated with weighted values;
causing, with the processor, at least one constraint to have a higher priority than other;
generating, with the processor, a long-term, macro schedule having durations up to months or years, said schedule matching projected demand in appointments with supply in clinician capacity and accounting for the plurality of constraints associated with the weighted priority values.

2. The method of claim 1, wherein a Graphical User Interface (GUI) is provided for receiving scheduling rules from user by:
identifying possible types of rules or constraints that are needed in practice for scheduling clinicians;
offering a GUI permitting a user to select a rule from a library of rule templates;
providing the user with a form unique to the chosen rule template by specifying parameter values specific to the selected rule including a textual description in natural language that is meaningful to user and a weighted value denoting relative priority of the rule; and
storing user-defined rules in a persistent database table as entries consisting of rule types, weight value, and rule-specific parameters.

3. The method in claim 1, further comprising:
converting user-defined rules stored as entries in a database table, at the time macro schedule is generated, into a set of mathematical inequalities to create a mathematical model which can to be solved by a MIP Solver.

4. The method in claim 3, further comprising:
creating the mathematical model specifically to allow a commercial MIP Solver to efficiently find a solution within a predetermined amount of time.

5. The method in claim 1, further comprising:
receiving a rule and storing a representation thereof in a database as an intermediate step; and
converting said rule to mathematical inequalities from database entry as a separate independent step;
wherein a flexible, programmable rule-based system is provided that adapts to different customer requirements without building a new mathematical model for each customer.

6. The method of claim 1, further comprising:
matching demand with supply at macro granularity by scheduling clinicians to tasks for whole days or half-days event blocks by using accurate information summarized in a single capacity number per clinician per work type;
wherein said singular capacity number is derived by mapping a duration of an event in a macro schedule onto a corresponding time block on one or more micro schedules (daily work templates) to calculate productivity at the granularity of minutes.

7. The method in claim 1, further comprising:
providing a Graphical User Interface to view and manually adjust a work calendar where, for each day box, a header is displayed comprising a pair of numbers summarizing expected demand and real-time total supply calculated as a sum of the scheduled clinician's capacities derived from a micro schedule.

8. The method of claim 1, further comprising:
transforming rules expressed in the database store along with daily demand and clinician capacities;
packing said rules into an XML (Extensible Markup Language) format is submitted to a remote server; and
unpacking said rules in said XML format and mapping said rules into mathematical inequalities to build a mathematical model for a MIP Solver to solve.

9. The method of claim 1, further comprising:
deriving a long-term macro schedule from user-specified rules; and
dynamically determining a daily clinician work template or micro schedule to flexibly match demand with supply by determining which clinician is best scheduled to work and the physician's rate of work when the physician works based on supply needs for a day.

10. The method of claim 1, further comprising:
using a Graphical User Interface a schedule of daily work template per clinician to define a clinician rate of work for different dates based on expected productivity of clinicians on specific dates.

11. A computer implemented method, comprising:
receiving, with a processor, over a plurality of channels, an initial projection of daily demand for various types of appointments for future dates;
receiving, with a processor, over a plurality of channels, actual appointments of various types for past dates;
receiving with a processor, over a plurality of channels expected percentage increase or decrease in a number of appointments of various types for specified date ranges based on external factors comprising a change in demographics;
projecting demand for appointments of various types based on past differences between projected demand and actual demand, along with expected percentage change using statistical inference and predictive analytics.

12. A computer implemented method, comprising:
receiving, with a processor, over a plurality of channels, an initial projection of daily clinician capacity expressed in clinician work templates;
receiving, with a processor, over a plurality of channels, actual appointments of various types serviced by clinicians for past dates;
projecting clinician capacity for appointments of various types based on past differences between projected productivity and actual productivity along with expected percentage change using statistical inference and predictive analytics; and
generating a schedule of daily work templates based on new projections for clinician capacity.

13. The method of claim 1, wherein the weighted priority values produce a hierarchy of constraints among the plurality of constraints.
